(19) United States
(12) Patent Application Publication
(10) Pub. No.: US 2008/0242536 A1
(43) Pub. Date: Oct. 2, 2008

(54) Metal Oxide with High Thermal Stability and Preparing Method Thereof

(76) Inventors: Wan Jae Myeong, Daejeon (KR); Joo Hyeong Lee, Daejeon (KR); Kyu Ho Song, Daejeon (KR)

Correspondence Address: ABELMAN, FRAYNE & SCHWAB, 666 THIRD AVENUE, 10TH FLOOR, NEW YORK, NY, 10017, US

(21) Appl. No.: 12/065,917

(22) PCT Filed: Aug. 28, 2006
(86) PCT No.: PCT/KR2006/003373

§ 371 Date: Mar. 6, 2008

(30) Foreign Application Priority Data
Sep. 8, 2005 (KR) 1020050083800

(51) Int. Cl. B01J 23/10

(52) U.S. Cl. 502/304; 502/355; 502/302

(57) ABSTRACT

Disclosed are metal oxide having high thermal stability and a preparation method thereof, specifically including continuously reacting a reaction mixture, composed of (i) water, (ii) a first metal salt including an aqueous cerium compound and (iii) a second metal salt including an aqueous aluminum compound, at 200˜700° C. under pressure of 180-550 bar, the reaction product having a molar ratio of metal, other than aluminum, to aluminum of 0.1˜10.

### TECHNICAL FIELD

The present invention relates to metal oxide having high thermal stability and a method of preparing the same, in which the specific surface area of metal oxide is maintained very high even after high-temperature calcinations, compared to conventional materials for storing oxygen, advantageously leading to oxygen storage oxide nanoparticles having high thermal stability.

The metal oxide prepared by the method of the present invention may be used as oxygen storage capacity (OSC) material or a support for a three way catalyst for the purification of exhaust gas from gasoline vehicles, and may also be used for the purification of exhaust gas of diesel vehicles, chemical reaction, or in an oxygen sensor for detecting oxygen therein. Preferably, the metal oxide is predicted to be suitable for use as such OSC material or support for a three way catalyst for the purification of exhaust gas of gasoline vehicles.

### BACKGROUND ART

Generally, a three way catalyst functions to convert carbon monoxide (CO), hydrocarbons, or nitrogen oxide (NOₓ), into carbon dioxide, water, or nitrogen, which are materials having low environmental loads or which are less toxic, through oxidation or reduction. The three way catalyst is prepared by washcoating a porous honeycomb with precious metal, such as platinum (Pt), palladium (Pd), or rhodium (Rh), alumina, and oxygen storage material.

The OSC material of a three way catalyst for the purification of exhaust gas of vehicles is typically exemplified by cerium oxide, cerium oxide-zirconium oxide, and mixed cerium oxide. Although the three way catalyst causes carbon monoxide (CO), hydrocarbons, or nitrogen oxide (NOₓ) to be highly converted in a very narrow range of air-to-fuel ratio of about 14.6, it is disadvantageous in that the conversion is drastically decreased in a range falling outside of the above air-to-fuel ratio. Cerium has some advantages, such as easy conversion between Ce (III) and Ce (IV) and excellent properties, in which oxygen is stored in a fuel lean region and is released in a fuel rich region.

Fuel lean: Ce(III)₂O₃+1/2O₂→Ce(IV)O₂ (1)

Fuel rich: Ce(IV)O₂→Ce(III)₂O₃+1/2O₂ (2)

Thus, cerium, which importantly functions to alleviate the problem of conversion being drastically decreased by small fluctuations in the air-to-fuel ratio when used along with the three way catalyst, was adopted and applied in the early 1990s. However, the three way catalyst for the purification of exhaust gas of vehicles is inevitably exposed to high temperatures. In such a case, cerium oxide suffers because it has a drastically decreased specific surface area and a greatly increased crystal size, attributable to the fusion of pores or sintering of crystals, and furthermore, oxygen storage capacity and oxygen mobility are lowered, that is, thermal stability is decreased.

Therefore, various attempts to solve the problems have been made.

In the case where zirconium oxide is added to cerium oxide, the mixture thus obtained is known to increase with respect to thermal stability and the ability to store and release oxygen. In addition, when the mixture of cerium oxide and zirconium oxide is added with a third component, it is known that thermal stability and oxygen storage capacity are further increased, and the performance is changed depending on the synthesis method or compositions. The catalyst for exhaust gas of vehicles is prepared by washcoating a honeycombed support with OSC material and alumina, the alumina functioning to increase the thermal stability of cerium oxide. Moreover, when alumina is doped with lanthanum (La) or barium, the thermal stability of alumina itself is known to be greatly improved.

In order to prepare such mixed metal oxide, methods of blending a mixed metal salt solution, comprising cerium, zirconium, and aluminum, with an alkaline solution at a high speed are known. Further, the resultant precipitate is dried and then calcined at about 650° C. for 1 hour. However, this method is disadvantageous because the used alkali hydroxide is difficult to completely remove.

US Serial No. 2004/0186016 discloses a method of preparing metal oxide in the form of a mixture, a coating or a solid solution by adding a cerium salt and second metal oxide M1 (preferably, zirconium oxide) with ammonium oxalate to thus co-precipitate them, sequentially or simultaneously depositing or coating the co-precipitated material with third metal oxide M2 (preferably, aluminum), and subjecting the product to filtration, drying and calcination. As such, [Ce_{0.8}Zr_{0.2}O₂]*[0.4Al₂O₃] prepared in Example E7 has a specific surface area of 129 m²/g, but has a specific area of 82 m²/g after calcination at 650° C. for 4 hours, and therefore the thermal stability thereof is considered insufficient.

### DISCLOSURE

### Technical Problem

At high temperatures, to which it cannot but be exposed when used along with a three way catalyst, conventional material has some drawbacks, such as a drastically decreased specific surface area and difficulty in maintaining oxygen storage capacity as high as desired, due to the fusion of pores or sintering of crystals.

Therefore, leading to the present invention, intense and thorough research into techniques for preparing metal oxide, in which a specific surface area is not drastically decreased and thermal stability is excellent at high temperatures, carried out by the present inventors aiming to avoid the problems encountered in the related art, resulted in the finding that when OSC material containing cerium as a main component, is mixed with alumina, which is a main component of a three way catalyst, a metal oxide is synthesized, of which the specific surface area not being drastically decreased and the thermal stability thereof being excellent at high temperatures.

An object of the present invention is to provide a metal oxide having high thermal stability and a method of preparing the same.

### Technical Solution

In order to accomplish the above object, the present invention provides a method of preparing metal oxide, comprising continuously reacting a reaction mixture, composed of (i) water, (ii) a first metal salt including an aqueous cerium compound, and (iii) a second metal salt including an aqueous aluminum compound, at 200˜700° C. under pressure of 180˜550 bar, the reaction product having a molar ratio of metal, other than aluminum, to aluminum of 0.1˜10.

Preferably, the first metal salt further comprises a salt of at least one metal selected from among Ca, Sc, Sr, Zr, Y and lanthanides other than Ce.

Preferably, the first metal salt further comprises a zirconium salt.

Preferably, the second metal salt further comprises a salt of at least one metal selected from among alkali earth metals, lanthanides, and barium, and may include, for example, K, Ba, La, etc.

Preferably, the reaction mixture further comprises an alkaline solution or an acidic solution which is added in an amount of 0.1˜20 mol based on 1 mol of the metal compound, before or during the reaction.

Preferably, the alkaline solution is ammonia water.

Preferably, the above method further comprises separating, drying or calcining the reaction product. The separation process may be performed through a typical separation process, for example, microfiltration of the reaction product using a filter after cooling to 100° C. or lower, which is the allowable temperature for filter material. The drying process may be performed through a typical drying process, for example, spray drying, convection drying, or fluidized-bed drying, at 300° C. or lower. In the case of requiring an increase in the size of dried particles or crystals or a sintering, a calcination in oxidation or reduction atmosphere, or in the presence of water may be further performed at 400˜1200° C. As such, the calcination effect is poor at a temperature of less than 400° C., whereas the product has too low a specific surface area, due to excess sintering, at a temperature exceeding 1200° C., and is thus unsuitable for use in a catalyst. Further, in order to enhance the effect upon mixing and reaction, microwaves or ultrasonic waves may be applied.

Preferably, a pre-pressurized aqueous metal salt solution containing cerium and a pre-pressurized aqueous precipitant solution including ammonia water are mixed and precipitated to obtain a first precipitate p1. Then, the first precipitate p1 and a pre-pressurized aqueous aluminum salt solution are further mixed and precipitated to thus obtain a second precipitate p2, which is then further mixed and reacted with supercritical water or subcritical water.

In addition, the present invention provides a catalyst system, which is characterized in that it can treat exhaust gas from an internal combustion engine using metal oxide prepared by the method mentioned above.

### ADVANTAGEOUS EFFECTS

The present invention provides oxygen storage oxide nanoparticles, which have a very high specific surface area even after high-temperature calcinations, and thus exhibit superior thermal stability, compared to conventional OSC materials. Since the metal oxide of the present invention is synthesized through a high-temperature and high-pressure continuous process, the crystal size thereof is on the nano scale, and the crystallinity is very high. Further, during the synthesis through the method of the present invention, the thermal stability of cerium oxide itself is increased, which is believed to be due to the introduction, deposition or solution of some of the aluminum to lattices of cerium oxide. Therefore, unlike the simple mixture of cerium oxide and aluminum oxide, the particle size of the metal oxide of the present invention can be more stable and the specific surface area thereof can be less decreased even upon exposure at high temperatures, resulting in superior thermal stability.

### DESCRIPTION OF DRAWINGS

FIG. 1 is scanning electron micrographs (SEMs) (100,000 magnified) of metal oxide synthesized in Example 1:

(a) as synthesized, (b) after calcination at 600° C., and (c) after calcination at 1000° C.; and

FIG. 2 is SEMs (100,000 magnified) of metal oxide synthesized in Example 2:

(a) as synthesized, (b) after calcination at 600° C., and (c) after calcination at 1000° C.

### BEST MODE

Hereinafter, a detailed description will be given of the present invention.

According to the present invention, metal oxide is prepared by continuously reacting a reaction mixture comprising (i) water, (ii) a first metal salt including an aqueous cerium compound and (iii) a second metal salt including an aqueous aluminum compound at 200˜700° C. under pressure of 180˜550 bar. As such, if the reaction temperature is lower than 200° C. or the reaction pressure is less than 180 bar, the reaction rate is slow, and the solubility of the resulting oxide is relatively high, and hence the degree of recovery into a precipitate is lowered. On the other hand, if the reaction temperature and the reaction pressure are too high, economic benefits are negated.

In the present invention, the first metal salt includes a salt of at least one metal selected from among Ca, Sc, Sr, Zr, Y, and lanthanides other than Ce, and preferably includes a salt of Zr. Further, aluminum oxide may include boehmite, alumina, or stabilized alumina doped with at least one metal selected from among alkali earth metals, lanthanides, and barium, and preferably K, La, or Ba. As such, the metal oxide of the present invention is provided in the form of a mixture, a deposit, or a solid solution of metal oxide particles, containing cerium oxide, and aluminum oxide particles.

According to the present invention, before or during the reaction, it is preferred that an alkaline solution or an acidic solution be further added in an amount of 0.1˜20 mol based on 1 mol of the above metal salt, in which the alkaline solution is exemplified by ammonia water.

Preferably, a pre-pressurized aqueous metal salt solution containing cerium and a pre-pressurized aqueous precipitant solution including ammonia water are mixed and precipitated, yielding a first precipitate p1. Thereafter, the first precipitate p1 and a pre-pressurized aqueous aluminum salt solution are further mixed and precipitated, to thus obtain a second precipitate p2, which is then mixed and reacted with supercritical water or subcritical water. In such a case, when the first precipitate p1, which is in the form of cerium hydroxide, is added with the aqueous aluminum salt solution, the mixture of cerium hydroxide and aluminum hydroxide is obtained. Since the two hydroxides are present in the form of ultrafine particles, they are efficiently dispersed in water. Ultimately, the degree of mixing of hydroxides is high. Furthermore, the hydroxide mixture is mixed with supercritical water or subcritical water and thus allowed to react therewith, giving a reaction product in which the two oxides are well-mixed.

According to the present invention, the reaction product has a molar ratio of metal, other than aluminum, to aluminum of 0.1˜10. In this case, if the molar ratio is less than 0.1, the reaction product does not function as OSC material. On the other hand, if the molar ratio exceeds 10, thermal stability is worsened.

The metal oxide, prepared by the method of the present invention, has a specific surface area of at least 100 m²/g upon synthesis, and also, the specific surface area thereof is maintained in at least 40 m²/g upon calcination at 1000° C. for 6 hours in air. Preferably, upon synthesis, mixed cerium oxide has a particle size of 50 nm or less, and boehmite is in the form of a thin plate having a diameter of 500 nm or less. In addition, upon calcination, mixed cerium oxide has a particle size of 700 nm or less, and boehmite is in the form of a thin plate having a diameter of 700 nm or less.

The metal oxide prepared by the method of the present invention is used as OSC material or catalyst support to thus serve for a catalyst system for the treatment of exhaust gas from an internal combustion engine.

That is, the metal oxide prepared by the method of the present invention may be used as OSC material or a support for a three way catalyst for use in the purification of exhaust gas of gasoline vehicles, and further, may be for the purification of exhaust gas of diesel vehicles, chemical reaction or in an oxygen sensor for detecting oxygen therein. Preferably, such a metal oxide is expected to be useful as the OSC material or support of a three way catalyst for the purification of exhaust gas of gasoline vehicles.

### MODE FOR INVENTION

A better understanding of the present invention may be obtained through the following examples which are set forth to illustrate, but are not to be construed as the limit of the present invention.

### Example 1

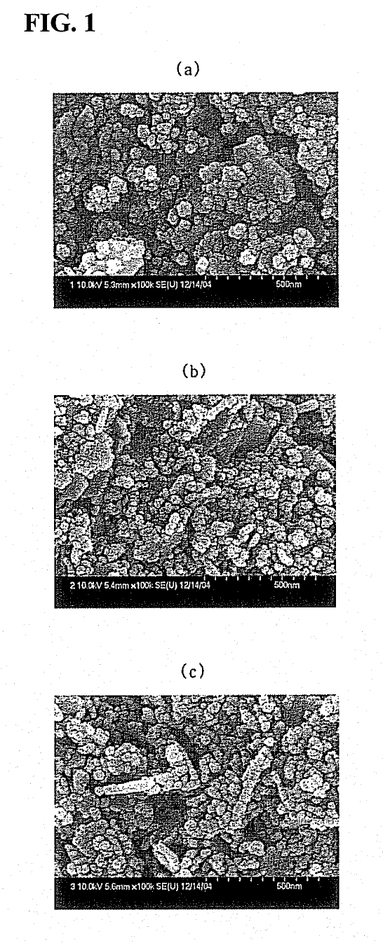

An aqueous mixture solution, comprising 5.81 wt % of zirconyl nitrate [30 wt % aqueous solution as ZrO₂], 6.17 wt % of cerium nitrate [Ce(NO₃)₃.6H₂O], and 9.02 wt % of aluminum nitrate [Al(NO₃)₃.9H₂O], was pumped at a rate of 8 g per min through a tube having an outer diameter of ¼ inch and pressurized at 250 bar. 16.34 wt % of ammonia water [28 wt % NH₃] was pumped at a rate of 8 g per min through a tube having an outer diameter of ¼ inch and pressurized at 250 bar. The pressurized aqueous mixture solution, comprising zirconyl nitrate, cerium nitrate, and aluminum nitrate, and the pressurized ammonia water were pumped into a tube-shaped continuous line mixer to thus be instantly mixed, and then allowed to precipitate for a residence time of about 30 sec. Further, deionized water was pumped at a rate of 96 g per min through a tube having an outer diameter of ¼ inch, preheated to 550° C., and pressurized at 250 bar. Subsequently, the deionized water thus preheated and the precipitate produced from the line mixer, which were in a state of being pressurized, were pumped into a continuous line reactor to thus be instantly mixed. The resultant reaction mixture, the temperature of which was controlled to 400° C., was allowed to react for a residence time of 10 sec or less. The slurry produced after the reaction was cooled and the particles were separated. The separated particles were dried in an oven at 100° C. The dried particles were calcined in an oxidation furnace at each of 725° C., 1000° C. and 1100° C. for 6 hours. The specific surface areas (BET) of the dried sample and the samples calcined at 725° C., 1000° C. and 1100° C. were measured to be 150, 95, 48, and 30 m²/g, respectively. The SEM images of the synthesized sample, the sample calcined at 600° C. for 6 hours, and the sample calcined at 1000° C. for 6 hours are shown in FIG. 1. The cerium oxide and zirconium oxide were in the form of a spherical agglomerate, the particle diameter of the agglomerate ranging from 5 to 50 nm. In addition, aluminum oxide was in the form of a plate or hexagonal plate, the diameter of the plate being 50˜300 nm. After the heat treatment, the shape of the sample was hardly changed, resulting in high thermal stability.

### Example 2

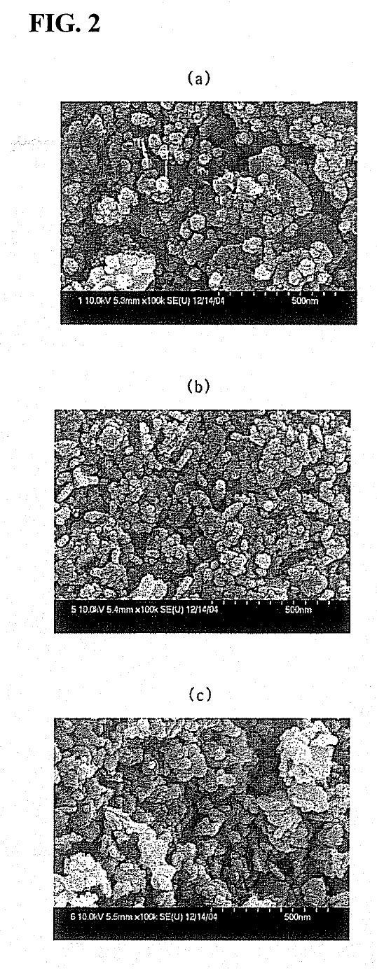

An aqueous mixture solution, comprising 2.43 wt % of zirconyl nitrate, 2.58 wt % of cerium nitrate, 0.37 wt % of lanthanum nitrate [La(NO₃)₃.6H₂O], and 15.62 wt % of aluminum nitrate, was pumped at a rate of 8 g per min through a tube having an outer diameter of ¼ inch, and pressurized at 250 bar. 16.88 wt % of ammonia water was pumped at a rate of 8 g per min through a tube having an outer diameter of ¼ inch and pressurized at 250 bar. The pressurized aqueous mixture solution, comprising zirconyl nitrate, cerium nitrate, lanthanum nitrate, and aluminum nitrate, and the pressurized ammonia water were pumped into a tube-shaped continuous line mixer to thus be instantly mixed, and then allowed to precipitate for a residence time of about 30 sec. Further, deionized water was pumped at a rate of 96 g per min through a tube having an outer diameter of ¼ inch, preheated to 550° C., and pressurized at 250 bar. Subsequently, the preheated deionized water and the precipitate resulting from the line mixer, which were in a state of being pressurized, were pumped into a continuous line reactor to thus be instantly mixed. The resultant reaction mixture, the temperature of which was controlled to 400° C., was allowed to react for a residence time of 10 sec or less. The slurry produced after the reaction was cooled and the particles were separated. The separated particles were dried in an oven at 100° C. The dried particles were calcined in an oxidation furnace at each of 725° C., 1000° C. and 1100° C. for 6 hours. The specific surface areas (BET) of the dried sample and the samples calcined at 725° C., 1000° C. and 1100° C. were measured to be 106, 95, 65, and 45 m²/g, respectively. The SEM images of the synthesized sample, the sample calcined at 600° C. for 6 hours, and the sample calcined at 1000° C. for 6 hours are shown in FIG. 2. The cerium oxide and zirconium oxide were in the form of a spherical agglomerate, the particle diameter of the agglomerate ranging from 5 to 30 nm. In addition, aluminum oxide was in the form of a plate or hexagonal plate, the diameter of the plate being 50˜200 nm. After the heat treatment, the shape of the sample was hardly changed, resulting in high thermal stability.

### Example 3

An aqueous mixture solution, comprising 2.10 wt % of zirconyl nitrate, 0.56 wt % of cerium nitrate, and 18.34 wt % of aluminum nitrate, was pumped at a rate of 8 g per min through a tube having an outer diameter of ¼ inch, and was pressurized at 250 bar. 17.17 wt % of ammonia water was pumped at a rate of 8 g per min through a tube having an outer diameter of ¼ inch and pressurized at 250 bar. The pressurized aqueous mixture solution, comprising zirconyl nitrate, cerium nitrate, and aluminum nitrate, and the pressurized ammonia water were pumped into a tube-shaped continuous line mixer to thus be instantly mixed, and were then allowed to precipitate for a residence time of about 30 sec. Further, deionized water was pumped at a rate of 96 g per min through a tube having an outer diameter of ¼ inch, preheated to 550° C., and pressurized at 250 bar. Subsequently, the preheated deionized water and the precipitate resulting from the line mixer, which were in a state of being pressurized, were pumped into a continuous line reactor to thus be instantly mixed. The resultant reaction mixture, the temperature of which was controlled to 400° C., was allowed to react for a residence time of 10 sec or less. The slurry produced after the reaction was cooled and the particles were separated. The separated particles were dried in an oven at 100° C. The dried particles were calcined in an oxidation furnace at each of 725° C., 1000° C. and 1100° C. for 6 hours. The specific surface areas (BET) of the dried sample and the samples calcined at 725° C., 1000° C. and 1100° C. were measured to be 120, 95, 67, and 50 m²/g, respectively.

### Comparative Examples 1-3

Respective comparative examples were performed in the same manner as in Examples 1, 2 and 3, with the exception that aluminum nitrate was not added. Further, the sample was added with boehmite (commercially available) having a specific surface area of 71 m²/g at a molar ratio of 1:1, 1:4, and 1:9, and then calcined at each of 725° C., 1000° C. and 1100° C. for 6 hours. The specific surface areas (BET) of the mixed sample and the samples calcined at 725° C., 1000° C. and 1100° C. are given in Table 1 below.

TABLE 1
Specific Surface Area (BET) of Each Sample

| | | C. Ex. 1 | | | C. Ex. 2 | | | C. Ex. 3 | |
|---|---|---|---|---|---|---|---|---|---|
| | Ex. 1 | A | B | Ex. 2 | A | B | Ex. 3 | A | B |
| Dried Sample | 150 | 120 | 95 | 106 | 125 | 73 | 120 | 130 | 67 |
| 725 | 95 | 70 | 70 | 95 | 80 | 65 | 95 | 75 | 62 |
| 1000 | 48 | 22 | 40 | 65 | 44 | 54 | 67 | 25 | 53 |
| 1100 | 30 | 8 | 15 | 45 | 20 | 32 | 50 | 7 | 31 |

Note:
A: before mixing with boehmite/B: after mixing with boehmite

1. method of preparing metal oxide, comprising continuously reacting a reaction mixture, composed of (i) water, (ii) a first metal salt including an aqueous cerium compound, and (iii) a second metal salt including an aqueous aluminium compound, at 200-700° C. under pressure of 180-550 bar, a reaction product thereof having a molar ratio of metal, other than aluminium, to aluminium of 0.1-10.

2. The method according to claim 1, wherein the first metal salt further comprises a salt of at least one metal selected from the group consisting of Ca, Sc, Sr, Zr, Y and lanthanides other than Ce.

3. The method according to claim 1, wherein the first metal salt further comprises a zirconium salt.

4. The method according to claim 1, wherein the second metal salt farther comprises a salt of at least one metal selected from the group consisting of alkali earth metals, lantanides, and barium.

5. The method according to claim 1, wherein the reaction mixture further comprises an alkaline solution or an acidic solution which is added in an amount of 0.1-20 mol based on 1 mol of the metal salt, before or during the reacting.

6. The method according to claim 5, wherein the alkaline solution is ammonia water.

7. The method according to claim 1, wherein the continuously reacting is performed by mixing and precipitating a pre-pressurized aqueous metal salt solution containing cerium and a pre-pressurized aqueous precipitant solution including ammonia water to thus prepare a first precipitate (p1), and further mixing and precipitating the first precipitate (p1) and a pre-pressurized aqueous aluminium salt solution to thus obtain a second precipitate (p2), which is then mixed and reacted with supercritical water or subcritical water.

8. The method according to claim 1, further comprising at least one post-treatment selected from the group consisting of separation, drying, and calcinations of the reaction product.

9. A mixture of metal oxides prepared according to the method of claim 1 having a specific surface area of at least 100 m²/g before calcination and a specific surface area of at least 40 m²/g upon calcination at 1000° C. for 6 hours in air.

10. A catalyst system for treatment of exhaust gas from an internal combustion engine using the mixture of metal oxides of claim 9.

11. The mixture of metal oxides prepared according to the method of claim 2 and having a specific surface area of at least 100 m²/g before calcination and a specific surface area of at least 40 m²/g upon calcination at 1000° C. for 6 hours in air.

12. The mixture of metal oxides prepared according to the method of claim 3 and having a specific surface area of at least 100 m²/g before calcination and a specific surface area of at least 40 m²/g upon calcination at 1000° C. for 6 hours in air.

13. The mixture of metal oxides prepared according to the method of claim 4 and having a specific surface area of at least 100 m²/g before calcination and a specific surface area of at least 40 m²/g upon calcination at 1000° C. for 6 hours in air.

14. The mixture of metal oxides prepared according to the method of claim 5 and having a specific surface area of at least 100 m²/g before calcination and a specific surface area of at least 40 m²/g upon calcination at 1000° C. for 6 hours in air.

15. The mixture of metal oxides prepared according to the method of claim 6 and having a specific surface area of at least 100 m²/g before calcination and a specific surface area of at least 40 m²/g upon calcination at 1000° C. for 6 hours in air.

16. The mixture of metal oxides prepared according to the method of claim 7 and having a specific surface area of at least 100 m²/g before calcination and a specific surface area of at least 40 m²/g upon calcination at 1000° C. for 6 hours in air.

17. The mixture of metal oxides prepared according to the method of claim 8 and having a specific surface area of at least 1100 m²/g before calcination and a specific surface area of at least 40 m²/g upon calcination at 1000° C. for 6 hours in air.
